(19) United States
(12) Patent Application Publication
(10) Pub. No.: US 2016/0066541 A1
(43) Pub. Date: Mar. 10, 2016

(54) Methods and Apparatus for Restraining an Animal

(71) Applicant: WOSS Enterprises, LLC, Antioch, CA (US)

(72) Inventors: Steven Storum, Antioch, CA (US); Wolfgang Ott, Antioch, CA (US)

(21) Appl. No.: 14/478,879

(22) Filed: Sep. 5, 2014

(51) Int. Cl. A01K 15/04; A01K 1/04; A01K 13/00; A01K 1/06

(52) U.S. Cl. CPC A01K 15/04; A01K 1/0613; A01K 1/04; A01K 13/00

(57) ABSTRACT

An animal restraint in which a multipurpose appliance having a cam buckle, a carabiner and a large loop is disposed between a groomer's stand and a slip lead strap, with the slip lead strap secured in the cam buckle and the carabiner attaching the appliance to the groomer's stand.

### FIELD OF INVENTION

The present invention relates to animal restraints typically used by groomers, veterinarians and the like to limit the motion of animals (mostly dogs and cats) on an examination or groomer's table.

### BACKGROUND

Animal restraints (such as grooming stands, examination loops, grooming harnesses and grooming nooses and such devices) are well known and commonly used by groomers, veterinarians and the like. Those restraints known in the art have several drawbacks including, without limitation, a need to adjust the height of the stand and have available straps of different sizes to accommodate animals of different sizes.

A slip lead harness (slip lead) typically used in connection with a grooming stand is a one-piece collar and leash comprised of a single strap with a ring (loop) attached at one end. The other end of the strap is pulled through the ring to form a loop that is placed over the animal's head and pulled tight to form a choke collar (noose). Slip leads are used by veterinarians, grooming houses, and shelters for quick and easy control over animals. The length of the slip lead is typically four feet or six feet and is not adjustable in length.

Slip lead harnesses (nooses) have serious disadvantages. An animal undergoing grooming can easily move off the table, leaving it hanging by its neck from the noose. While an animal is in the noose on the table, the noose can put pressure around its throat, causing discomfort and injury and even more so if the animal starts to struggle, making the job hard for the handler.

### SUMMARY OF THE INVENTION

A multipurpose restraint appliance is disposed between a slip lead strap and a grooming stand providing adjustability whereby a single slip lead can accommodate animals of different sizes without adjusting the height of the stand and further serves as a leash to guide the animal after its procedure has been completed. In addition, in one embodiment, the appliance provides for quick release of an animal from the restraint when necessary without having to pull it over the animal's head. The use of two restraints employing the novel appliance further allows a groomer or veterinarian to keep an animal up on all fours (standing) during a procedure.

### DESCRIPTION OF DRAWINGS

FIG. 1 is a side perspective view of a prior art restraint;

FIG. 2 is a side perspective view of the multipurpose restraint appliance of the present invention in two embodiments shown in relationship to a dog being restrained on a groomer's (or veterinarian's) table;

FIG. 3A is a right perspective view of the multipurpose restraint appliance of the present invention shown in combination with a slip lead harness;

FIG. 3B is a right perspective view of a modified slip lead harness;

FIG. 4 is a side view of a three loop embodiment of the invention; and

FIG. 5 is a side view of a two loop embodiment of the invention.

### DETAILED DESCRIPTION OF THE INVENTION

As used herein and in the claims, the following terms are to be understood to have the following meanings:

(a) “attachment device”: a snap hook or carabiner or simple hook;

(b) “snap hook”: a mechanical device (usually metal) having a closed loop at one end and a loop at the other end that includes a spring-loaded gate used to quickly and reversibly connect components;

(c) “carabiner”: a rigid (usually metal) loop with a spring-loaded gate used to quickly and reversibly connect components;

(d) “eyebolt”: a bolt (usually of metal) with a loop at its end to which other components (such as a carabiner or snap hook) can be attached;

(e) “strap”: a length of material including webbing material, rope, cord, wire or other suitable flexible material;

(f) “a one-way lock device”: a cam buckle, a rope ratchet and any such device that selectively allows a strap to move through it in one direction but not in the other direction.

Like components have been assigned the same number designations.

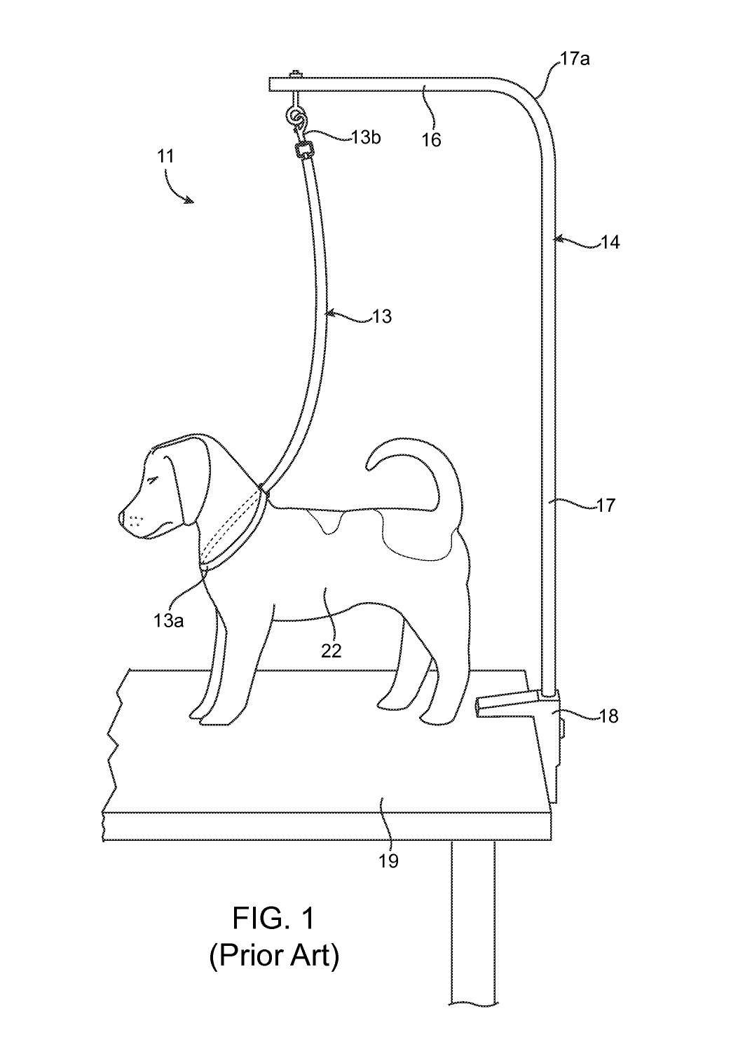

Referring to FIG. 1, a prior art animal restraint 11 typically includes a grooming stand 14 and a slip lead harness (“slip lead”) 13.

Grooming stand 14 comprises a vertically extending support leg 17 secured to the tabletop 19 by a bracket 18 and an integral attachment arm 16 extending horizontally from the top 17a support leg 17.

Slip lead 13 has a loop 13a at one end typically disposed around the neck of an animal 22 and an attachment device such as a snap hook 13b at its other end secured to the grooming stand attachment arm 16. The grooming stand 14 is adjusted to dispose the attachment arm 16 substantially above the tabletop 19 so that it is above the head of an animal 22 (typically, but not necessarily, a dog) with which the grooming stand 14 is to be used.

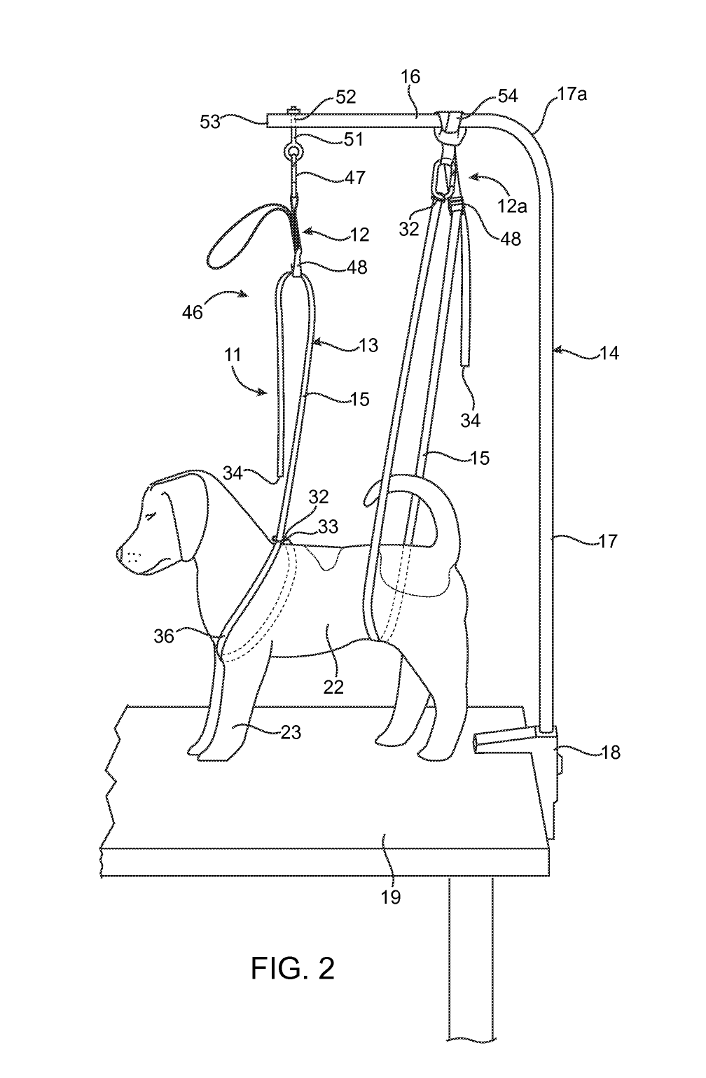

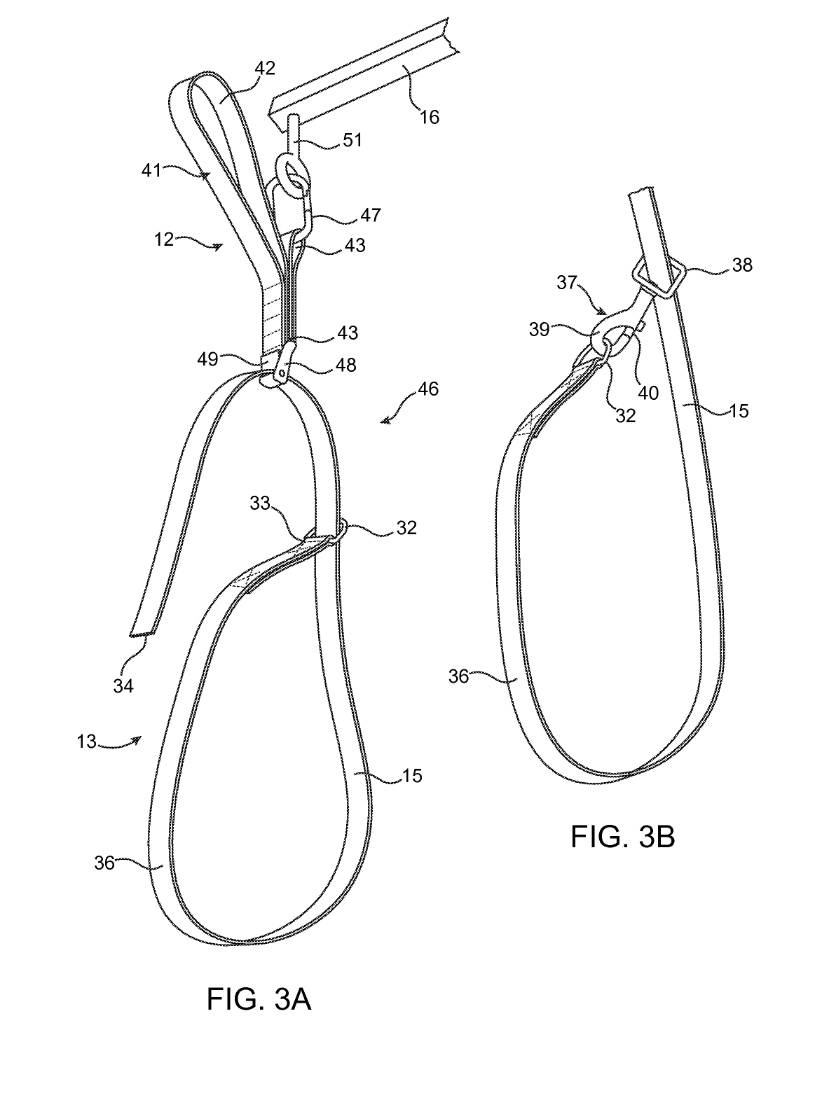

Referring also to FIGS. 2 and 3A, slip lead harness 13 comprises a slip lead strap 15 with ends 33 and 34 with a ring (loop) 32 at end 33. A multipurpose restraint appliance 12 is interposed between the slip lead harness 13 and the stand 14 such that the slip lead strap 15 is not affixed directly to the attachment arm 16 as in the prior art (FIG. 1).

In use, the second end 34 of strap 15 is threaded through ring 32 to form a loop 36 that is placed around the animal 22, preferably between its front legs 23, rather than its neck (to prevent the loop 36 from tightening around the animal's neck and causing discomfort or even choking).

In an alternative embodiment, as shown in FIG. 3B, an attachment device such as snap hook 37 having a closed loop 38 at one end and a gated loop 39 at its other end is interposed between the slip lead strap ring 32 and the strap 15. The slip lead ring 32 is secured in the gated loop 39, while the strap 15 passes through the snap hook closed loop 38. In this embodiment, the strap 15 can be attached to, and released from, the animal 22 by opening the gate 40 of loop 39 (in a manner well known for snap hooks) and withdrawing the ring 32 without having to pass loop 36 over the animal's head or hind quarters.

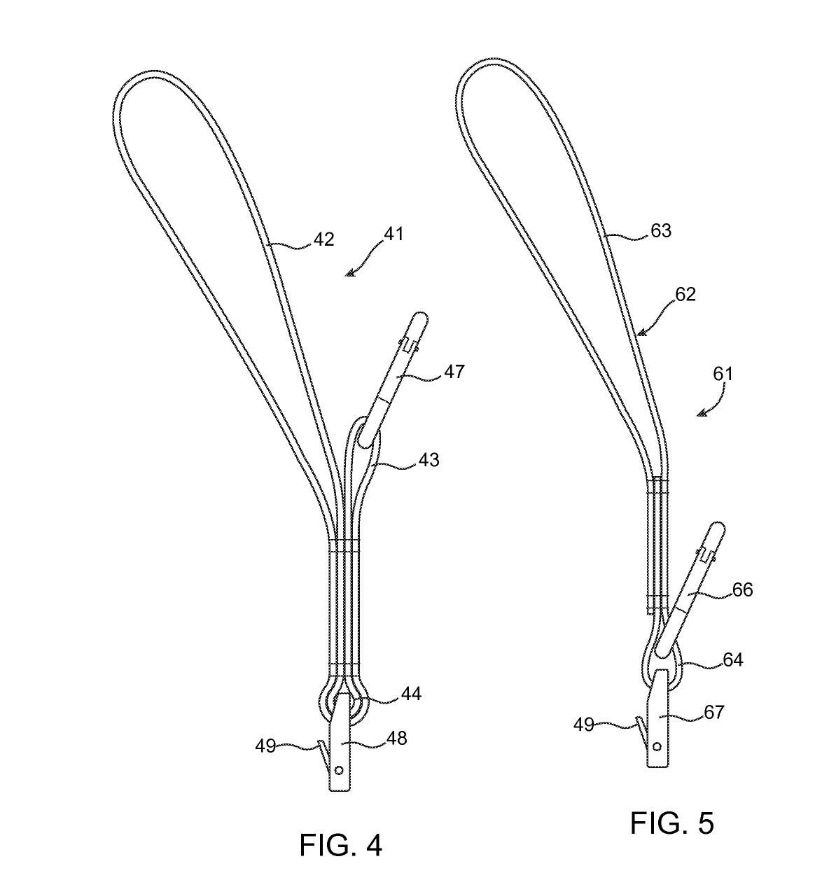

Referring to FIGS. 2, 3A and 4, in one embodiment, the multipurpose restraint appliance 12 comprises a utility strap 41 folded and sewn to create a first loop 42, a second loop 43 and a third loop 44. Utility strap 41 can be formed from a single length of webbing strap material that is folded and sewn at several locations to form loops 42, 43, and 44. It will understood by those skilled in the art that utility strap 41 can be formed from material other than webbing strap, such as rope, cord, or wire or like flexible material and from more than one piece and by securing means other than sewing, such as staples, snaps, rivets, and the like. Of importance is not so much how the loops of utility strap 41 are formed, but rather the functionality they provide.

An attachment device such as carabiner 47 is secured in second loop 43 and a cam buckle 48 is secured in third loop 44. First loop 42 is sized to accommodate the hand of a person (not shown) whereby the multipurpose restraint appliance 12, together with the slip lead harness 13, forms a leash 46 (FIG. 3A) useful for guiding an animal from place to place, such as from the tabletop 19 to a different location. When so used, the carabiner 47, which is located at one end of the leash, can be used to secure the leash 46 and thus the animal to a fence or other fixed object (not shown) to which the carabiner 47 can be attached.

Referring to FIG. 2, the multipurpose restraint appliance 12 is affixed to the attachment arm 16 by securing the carabiner 47 to an eyebolt 51 that is typically secured at a through hole 52 near the end 53 of the attachment arm 16. In prior art restraints, the end 34 of slip lead strap 15 would be attached directly to the attachment arm 16 (See FIG. 1).

The slip lead strap end 34 is threaded through the depending one-way lock device such as cam buckle 48 by which strap 15 is secured at any desired location along its length and preferably where the strap 15 is pulled snuggly around the animal 22. As is well known, a cam buckle 48 operates by a spring-loaded lever 49 which, when depressed (spring compressed), allows the strap 15 to pass freely, but when the lever 49 is released, the force of the lever 49 on the strap 15 secures the strap 15 in place against further movement out of the cam buckle 48.

The disposition of the cam buckle 48 between the attachment arm 16 and the slip lead strap 15 makes it possible to vary the length of strap 15 between the animal 22 and the attachment arm 16 and thereby accommodate animals of different sizes without having to use a different length slip lead strap 15 or adjust the height of the stand 17 for animals of different sizes.

Referring to FIGS. 2 and 5, in an alternative embodiment, a multipurpose restraint appliance 61 comprises a utility strap 62 folded and sewn to create a first loop 63 and a second loop 64. A carabiner 66 and a cam buckle 67 are both secured in second loop 64. First loop 63 is large enough to accommodate a person's hand and to form a securing knot, such as a Larks Knot, around attachment arm 26. An advantage of this embodiment is that it shortens the distance between the attachment arm 16 and the cam buckle 67, which further increases the space available between the tabletop 19 and the cam buckle 67 to accommodate an animal of large size.

Referring to FIG. 2, a second multipurpose restraint appliance 12a, is secured to attachment arm 16 to keep animal 22 standing on all fours. Multipurpose restraint appliance 12a can be identical to multipurpose restraint appliance 12 (as is shown), or it can be the embodiment of the multipurpose restraint appliance 61 shown in FIG. 5.

Because grooming arms 14 typically have only one (if any) through hole 52 for an eyebolt 51, it is not possible to attach the second multipurpose restraint appliance 12a to the attachment arm 16 by its carabiner 47 when multipurpose restraint appliance 12 already occupies the eyebolt 51 attachment device. Instead, multipurpose restraint appliance 12a is affixed to the attachment arm 16 by pulling the cam buckle 48 through the first loop 42 after it is wrapped around the attachment arm 16 to make a securing knot 54 (such as that commonly known as a Larks Knot or Girth Hitch), locating the cam buckle 48 and the carabiner 47 slightly below the attachment arm 16. The slip lead strap ring 32 is secured in the carabiner 47 and the second end 34 of the slip lead strap 15 is threaded through cam buckle 48 after first being passed underneath the animal 22. The slip lead strap 15 is secured in cam buckle 48 at a location that gently supports the hind quarters of the animal 22 at a height above the tabletop 19 that prevents it from sitting. The ability to form a securing knot 54 with the first loop 42 makes it possible to secure the second multipurpose connector 12a at any desired location along attachment arm 16. It also allows a multipurpose restraint appliance 12 or 12a to be connected to any attachment arm 16, including those without a through hole and an eyebolt or other attachment hardware.

Of course, various changes, modifications and alterations in the teachings of the present invention may be contemplated by those skilled in the art without departing from the intended spirit and scope thereof. As such, it is intended that the present invention only be limited by the terms of the appended claims.

What is claimed is:

1. A multipurpose restraint appliance for use with a slip lead strap and a grooming stand having an attachment arm, comprising:
a one-way lock device for receiving and securing the slip lead strap, and;
an attachment device for attaching said one-way lock device to the attachment arm.

2. The multipurpose restraint appliance of claim 1, further comprising:
a utility strap; wherein said attachment device and said one-way lock device are secured to said utility strap.

3. The multipurpose restraint appliance of claim 1 wherein said attachment device is a carabiner and said one-way lock device is a cam buckle.

4. The multipurpose restraint appliance of claim 2 wherein said utility strap further comprises a first loop large enough and flexible enough to form a securing knot around the attachment arm.

5. The multipurpose restraint appliance of claim 3 wherein said utility strap comprises a first loop, a second loop, and a third loop and wherein said cam buckle is attached to said second loop and said carabiner is attached to said third loop.

6. The multipurpose restraint appliance of claim 5 wherein said first loop is large enough and flexible enough to form a securing knot around the attachment arm.

7. The multipurpose restraint appliance of claim 3 wherein said utility strap comprises a first loop and a second loop and said carabiner and said cam buckle are both attached at said second loop.

8. The multipurpose restraint appliance of claim 3 wherein the slip lead strap has a first end, and further comprising:
a closed loop attached at the first end of the slip lead strap; and
an attachment device releasably affixed to said closed loop; and
a length of the slip lead strap in said snap hook.

9. The multipurpose restraint appliance of claim 8 wherein said snap hook has a first end and a second end, further comprising:
a gated loop at said first end of said snap hook and a closed loop at said second end of said snap hook;
wherein said gated loop is attached to said closed loop at said first end of said slip lead strap and a length of slip lead strap resides in said closed loop at said second end of said snap hook.

10. An animal restraint for use by groomers and veterinarians in conjunction with a groomer's stand having an elevated attachment arm, comprising:
a slip lead strap;
a multipurpose appliance disposed between said slip lead strap and the attachment arm comprising:
a utility strap;
a cam buckle attached to said utility strap and securing said slip lead strap;
a carabiner attached to said utility strap attaching said multipurpose appliance to the attachment arm.

11. The animal restraint of claim 10 wherein said utility strap comprises two loops and said cam buckle is attached at one said loop and said carabiner is attached at the other said loop.

12. The animal restraint of claim 10 wherein said utility strap comprises two loops and said cam buckle and said carabiner are both attached at one of said two loop.

13. The animal restraint of claim 10 wherein said utility strap comprises a first loop, a second loop and a third loop and said cam buckle is attached at said second loop and said carabiner is attached at said third loop.

14. The animal restraint of claim 10 wherein said first loop is of a size that can form a securing knot around the attachment arm.

15. A method of restraining a animal having two front legs using a grooming stand and a slip lead harness that includes a slip lead strap, comprising:
securing the slip lead harness around the animal;
securing a one-way lock device to the grooming stand;
securing a length of the slip lead strap in the one-way lock device; and
positioning the slip lead strap in the one-way lock device until the harness is firmly about the animal.

16. The method of claim 15 where the harness is secured between the front legs of the animal.

17. The method of claim 15 wherein the one-way lock device is a cam buckle.
